(19) United States
(12) Patent Application Publication
(10) Pub. No.: US 2006/0211791 A1
(43) Pub. Date: Sep. 21, 2006

(54) Inkjet inks comprising modified pigments having attached polymeric groups

(76) Inventors: Elizabeth G. Burns, Windham, NH (US); James A. Belmont, Acton, MA (US); Tianqi Liu, Waltham, MA (US); Sze-Ming Lee, Westford, MA (US)

Correspondence Address: Michelle B. Lando;Cabot Corporation, 157 Concord Road, Billerica, MA, 01821, US

(21) Appl. No.: 11/351,680

(22) Filed: Feb. 10, 2006

Related U.S. Application Data
(60) Provisional application No. 60/655,274, filed on Feb. 11, 2005.
(60) Provisional application No. 60/700,232, filed on Jul. 14, 2005.

(51) Int. Cl. C03C 17/00; C09D 11/00

(52) U.S. Cl. 523/160; 523/161

(57) ABSTRACT

The present invention relates to inkjet ink composition comprising a) a vehicle and b) a polymer modified pigment prepared by a “grafting from” polymerization process. Various embodiments for the process for preparing the polymer modified pigment as well as the polymer modified pigments themselves are disclosed.

### CROSS-REFERENCE TO RELATED APPLICATIONS

This patent application claims the benefit of U.S. Provisional Patent Application Nos. 60/655,274, filed Feb. 11, 2005, and 60/700,232, filed Jul. 14, 2005.

### BACKGROUND OF THE INVENTION

1. Field of the Invention.

The present invention relates to inkjet ink compositions comprising modified pigments having attached polymeric groups, wherein the polymeric groups are prepared by a “grafting from” polymerization process.

2. Description of the Related Art.

An inkjet ink composition generally consists of a vehicle, which functions as a carrier, and a colorant such as a dye or pigment. Additives and/or cosolvents can also be incorporated in order to adjust the inkjet ink to attain the desired overall performance properties.

In general, pigments alone are not readily dispersible in liquid vehicles. A variety of techniques have been developed which can provide stable pigment dispersions that can be used in inkjet printing. For example, dispersants can be added to the pigment to improve its dispersibility in a particular medium. Examples of dispersants include water-soluble polymers and surfactants. Typically, these polymeric dispersants have a molecular weight less than 20,000 in order to maintain solubility and therefore pigment stability.

The surface of pigments contain a variety of different functional groups, and the types of groups present depend on the specific class of pigment. Several methods have been developed for grafting materials and, in particular, polymers to the surface of these pigments. For example, it has been shown that polymers can be attached to carbon blacks containing surface groups. However, methods which rely on the inherent functionality of a pigment's surface cannot be applied generally because not all pigments have the same specific functional groups.

Methods for the preparation of modified pigment products have also been developed which can provide a pigment with a variety of different attached functional groups. For example, U.S. Pat. No. 5,851,280 discloses methods for the attachment of organic groups onto pigments including, for example, attachment via a diazonium reaction wherein the organic group is part of the diazonium reagent.

Other methods to prepare modified pigments have also been described. For example, PCT Publication No. WO 01/51566 discloses methods of making a modified pigment by reacting a first chemical group and a second chemical group to form a pigment having attached a third chemical group. Ink compositions, including inkjet inks, containing these pigments are also described. Also, U.S. Pat. No. 5,698,016 discloses a composition comprising an amphiphilic ion and a modified carbon product comprising carbon having attached at least one organic group. The organic group has a charge opposite to the amphiphilic ion. Also disclosed are aqueous and non-aqueous ink and coating compositions incorporating this composition, including ink jet ink compositions. Other methods for preparing modified pigments, including polymer modified pigments have also been described in, for example, U.S. Pat. Nos. 6,664,312, 6,551,393, 6,372,820, 6,368,239, 6,350,519, 6,337,358, and 6,102,380.

While these methods provide modified pigments having attached groups, there remains a need for improved processes for attaching groups and, in particular, polymeric groups, to a pigment. These additional methods may provide advantageous means for forming polymer modified pigments.

### SUMMARY OF THE INVENTION

The present invention relates to an inkjet ink composition comprising a) a vehicle and b) a polymer modified pigment comprising a pigment having attached at least one polymeric group. The polymer modified pigment is prepared by a process comprising the step of polymerizing at least one polymerizable monomer from a modified pigment. Preferably, the modified pigment comprises the pigment having attached at least one transferable atom or group. In one embodiment, the polymerizable monomer is a radically polymerizable monomer and the transferable atom or group is a radically transferable atom or group. In another embodiment, the polymerizable monomer is an anionically or cationically polymerizable monomer and the transferable atom or group is an anionically or cationically transferable atom or group. For both of these embodiments, at least one of the polymerizable monomers may comprise a hydrophilic nonionic group or a reactive functional group capable of being converted to a hydrophilic nonionic group or an ionic group. In yet another embodiment, the polymerizable monomer comprises an ionizable group. For the inkjet ink compositions of the present invention, the polymer modified pigment preferably has an average particle size of less than or equal to 500 nm in the inkjet ink composition and/or has an attached polymeric group that comprises an ionic group in an amount of from about 0.3 to about 12 mmoles of ionic groups per gram of polymer modified pigment. The present invention further relates to a process for preparing a polymer modified colored pigment comprising the steps disclosed herein as well as the polymer modified colored pigment produced by this process.

It is to be understood that both the foregoing general description and the following detailed description are exemplary and explanatory only and are intended to provide further explanation of the present invention, as claimed.

### DETAILED DESCRIPTION OF THE INVENTION

The present invention relates to inkjet ink compositions comprising polymer modified pigments prepared by processes disclosed herein.

The inkjet ink composition of the present invention comprises a) a vehicle and b) a polymer modified pigment. The vehicle may be a non-aqueous vehicle or an aqueous vehicle. Preferably the vehicle is an aqueous vehicle that contains greater than 50% water. For example, the aqueous vehicle can be water or mixtures of water with water miscible solvents such as alcohols.

The polymer modified pigment comprises a pigment having attached at least one polymeric group. The pigment can be any type of pigment conventionally used by those skilled in the art, such as carbon products and organic colored pigments including blue, black, brown, cyan, green, white, violet, magenta, red, orange, or yellow organic pigments. Mixtures of different pigments can also be used. Examples of carbon products include graphite, carbon black, vitreous carbon, activated charcoal, carbon fiber, or activated carbon blacks. Representative examples of carbon black (Pigment Black 7) include channel blacks, furnace blacks and lamp blacks, and include, for example, carbon blacks sold under the Regal®, Black Pearls®, Elftex®, Monarch®, Mogul®, and Vulcan® trademarks available from Cabot Corporation (such as Black Pearls® 2000, Black Pearls® 1400, Black Pearls® 1300, Black Pearls® 1100, Black Pearls® 1000, Black Pearls® 900, Black Pearls® 880, Black Pearls® 800, Black Pearls® 700, Black Pearls® L, Elftex® 8, Monarch® 1400, Monarch® 1300, Monarch® 1100, Monarch® 1000, Monarch® 900, Monarch® 880, Monarch® 800, Monarch® 700, Mogul® L, Regal® 330, Regal® 400, Vulcan® P). Suitable classes of organic colored pigments include, for example, anthraquinones, phthalocyanine blues, phthalocyanine greens, diazos, monoazos, pyranthrones, perylenes, heterocyclic yellows, quinacridones, quinolonoquinolones, and (thio)indigoids. Such pigments are commercially available in either powder or press cake form from a number of sources including, BASF Corporation, Engelhard Corporation and Sun Chemical Corporation. Examples of other suitable organic colored pigments are described in the Colour Index, 3rd edition (The Society of Dyers and Colourists, 1982).

In addition, the pigment may be a pigment, such as a carbon product, that has been oxidized using an oxidizing agent in order to introduce ionic and/or ionizable groups onto the surface. Oxidized pigments prepared in this way have been found to have a higher degree of oxygen-containing groups on the surface. Oxidizing agents include, but are not limited to, oxygen gas, ozone, peroxides such as hydrogen peroxide, persulfates, including sodium and potassium persulfate, hypohalites such a sodium hypochlorite, oxidizing acids such a nitric acid, sodium chlorate, nitrogen oxides including NO₂, and transition metal containing oxidants, such as permanganate salts, osmium tetroxide, chromium oxides, or ceric ammonium nitrate. Mixtures of oxidants may also be used, particularly mixtures of gaseous oxidants such as oxygen and ozone. Pigments which have been modified using surface modification methods such as sulfonylation to introduce ionic or ionizable groups may also be used.

The pigment may also be a multiphase aggregate comprising a carbon phase and a silicon-containing species phase or a multiphase aggregate comprising a carbon phase and a metal-containing species phase. The multiphase aggregate containing the carbon phase and the silicon-containing species phase can also be considered a silicon-treated carbon black aggregate and the multiphase aggregate containing a carbon phase and a metal-containing species phase can be considered to be a metal-treated carbon black aggregate as long as one realizes that in either case, the silicon-containing species and/or metal-containing species are a phase of the aggregate just like the carbon phase. The multiphase aggregates do not represent a mixture of discrete carbon black aggregates and discrete silica or metal aggregates. Rather, the multiphase aggregates that can be used as the pigment in the present invention include at least one silicon-containing or metal-containing region concentrated at or near the surface of the aggregate (but put of the aggregate) and/or within the aggregate. The aggregate, thus contains at least two phases, one of which is carbon and the other of which is a silicon-containing species, a metal-containing species, or both. The silicon-containing species that can be a part of the aggregate is not attached to a carbon black aggregate like a silane coupling agent would be, but actually is part of the same aggregate as the carbon phase.

The metal-treated carbon blacks are aggregates containing at least a carbon phase and a metal-containing species phase. The metal-containing species include compounds containing aluminum, zinc, magnesium, calcium, titanium, vanadium, cobalt, nickel, zirconium, tin, antimony, chromium, neodymium, lead, tellurium, barium, cesium, iron, and molybdenum. The metal-containing species phase can be distributed through at least a portion of the aggregate and is an intrinsic part of the aggregate. The metal-treated carbon black may also contain more than one type of metal-containing species phase or the metal-treated carbon black can also contain a silicon-containing species phase and/or a boron-containing species phase.

The details of making these multiphase aggregates are explained in U.S. patent application Ser. Nos.: 08/446,141, filed May 22, 1995; 08/446,142, filed May 22, 1995; 08/528,895, filed Sep. 15, 1995; 08/750,017, filed Nov. 22, 1996, which is a National Phase Application of PCT No. WO 96/37547, filed May 21, 1996; 08/828,785, filed Mar. 27, 1997; 08/837,493 filed Apr. 18, 1997; and 09/061,871 filed Apr. 17, 1998. All of these patent applications are hereby incorporated in their entireties herein by reference.

A silica-coated carbon product can also be used as the pigment, which is described in PCT Application No. WO 96/37547, published Nov. 28, 1996, and is hereby incorporated in its entirety herein by reference. In addition, coated pigments, such as silica-coated pigments, where the pigments can be any of those described above, may also be used. For such coated pigments, as well as for the metal-treated carbon blacks and multiphase aggregates described above, coupling agents having a functionality capable of reacting with the coating or silica or metal phase, may be used to provide necessary or desirable functionality to the pigment.

The pigment can have a wide range of BET surface areas, as measured by nitrogen adsorption, depending on the desired properties of the pigment. For example, the pigment surface are may be from about 10 m²/g to about 2000 m²/g including from about 10 m²/g to about 1000 m² /g and from about 50 m²/g to about 500 m²/g. As is known to those skilled in the art, a higher surface area will correspond to a smaller particle size, for the same particle structure. If a higher surface area is preferred and is not readily available for the desired application, it is also well recognized by those skilled in the art that the pigment may be subjected to conventional size reduction or comminution techniques, such as media milling, jet milling, microfluidization, or sonication to reduce the pigment to a smaller particle size, if desired. In addition, when the pigment is a particulate material comprising aggregates of primary particles, such as carbon black, the pigment may have a structure which ranges from about 10 cc/100 g to about 1000 cc/100 g, including from about 40 cc/100 g to about 200 cc/100 g.

The polymer modified pigment used in the inkjet ink of the present invention is prepared by a process which comprises the step of polymerizing at least one polymerizable monomer from a modified pigment. The polymeric group may be a variety of different types of polymeric groups, including, for example, a homopolymer, a random copolymer, a block copolymer, a graft copolymer, a branched copolymer, or an alternating copolymer.

In general, there are three types of methods that can be used to prepare pigments having attached at least one polymeric group. These are sometimes referred to as “grafting onto”, “grafting through”, and “grafting from” processes. “Grafting onto” generally involves the reaction of polymeric materials having reactive functional groups onto the surface of a particle, such as a pigment. For this type of process, polymer that has reacted with the surface may cause steric hindrance, thereby preventing additional polymeric material from reaching the surface of the pigment and limiting the amount of polymer attached to the pigment surface. “Grafting through” processes generally involve the polymerization of monomers in the presence of a modified pigment having attached at least one polymerizable group. However, similar to the “grafting to” method, the presence of attached polymer may limit further attachment since the attached polymer may sterically hinder the growing polymer chains from reaching the polymerizable group on the pigment surface. By comparison, a “grafting from” process typically comprises forming initiation sites on the surface of the pigment and polymerizing monomers directly from the initiation site. “Grafting from” a surface typically affords a higher grafting density due to the much higher diffusion rate of small molecules (i.e., monomers) as compared to polymers in the “grafting onto” or “grafting through” processes.

The polymer modified pigment used in the inkjet ink composition of the present invention is prepared by a “grafting from” process. Any “grafting from” process known in the art may be used. For example, the polymer modified pigment may be prepared by a process in which at least one polymerizable monomer is polymerized “from” a pigment having attached at least one transferable atom or group. Alternatively, conventional free radical polymerization may be used in which at least one polymerizable monomer is polymerized “from” a pigment having an attached initiator group. Preferably, the polymer modified pigment is prepared using a polymerization process comprising the step of polymerizing at least one polymerizable monomer from a pigment having attached at least one transferable atom or group. Examples of such polymerization processes include atom transfer radical polymerization (ATRP), stable free radical (SFR) polymerization, and reversible addition-fragmentation chain transfer polymerization (RAFT), as well as ionic polymerizations such as group transfer polymerization (GTP). These polymerizations typically, but not necessarily, comprise a relatively low stationary concentration of propagating chain ends in relation to dormant chain ends. When the chain is in the dormant state, the chain end comprises a transferable atom or group. The dormant chain end may be converted to a propagating chain end by loss of the transferable atom or group.

ATRP, SFR, and RAFT are living radical polymerization techniques which are used to prepare polymeric materials from radically polymerizable monomers using an initiator comprising a radically transferable atom or group. Each of these differ in the type of group being transferred. For example, ATRP polymerizations typically involve the transfer of halogen groups. Details concerning the ATRP process are described, for example, by Matyjaszewski in the Journal of American Chemical Society, vol. 117, page 5614 (1995), as well as in ACS Symposium Serves 768, and Handbook of Radical Polymerization, Wiley: Hoboken 2002, Matyjaszewski, K. and Davis, T., editors, all hereby incorporated by reference herein. SFR polymerizations generally involve the transfer of stable free radical groups, such as nitroxyl groups. Details concerning nitroxide mediated polymerizations are described in, for example, in Chapter 10 of The Handbook of Radical Polymerization, K. Matyjaszewski & T. Davis, Ed., John Wiley & Sons, Hoboken, 2002. RAFT processes, described by Chiefari et al. in Macromolecules, 1998, 31, 5559, differ from nitroxide-mediated polymerizations in that the group that transfers is, for instance, a thiocarbonylthio group, although many other groups have been demonstrated in, for example, McCormick and Lowe, Accounts of Chemical Research, 2004, 37, 312-325. In comparison, GTP is a polymerization technique in which an anionically or cationically polymerizable monomer is polymerized from an initiator comprising an ionically transferable atom or group, such as a silyl group (for example, a trimethylsilyl group). Details concerning the GTP process are described, for example, by Webster, et al. in the Journal of the American Chemical Society, (1983), 105(17), 5706-5708 and by Webster in the Encycl. Polym. Sci. Eng., (1987), 7, 580-588. Each of the above-cited references is incorporated in their entirety by reference herein.

In a first embodiment, the polymer modified pigment used in the inkjet ink composition of the present invention is prepared by a process comprising the step of polymerizing at least one radically polymerizable monomer from a modified pigment comprising a pigment having attached at least one radically transferable atom or group. This is a “grafting from” process since the radically polymerized monomer is polymerized “from” the modified pigment. Thus, the modified pigment provides the initiation sites for the polymerization.

The modified pigment comprises a pigment having attached at least one radically transferable atom or group. The pigment is the same as those described in more detail above. The radically transferable atom or group will depend on the type of radical polymerization process. As discussed above, for ATRP processes, the radically transferable atom or group may comprise a halogen, such as a haloalkyl ester group, a haloalkyl ketone group, or a haloalkyl amide group. Preferably the halogen is chlorine or bromine. For SFR processes, the radically transferable atom or group may comprise a nitroxide group while, for RAFT processes, the radically transferable atom or group may comprise a thiocarbonylthio group.

The radically transferable atom or group may be directly attached to the pigment or may be attached to the pigment through one or more linking groups. For example, the modified pigment may be a pigment having attached at least one radically transferable atom or group having the formula: 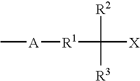
A is attached to the pigment. A and R¹, which can be the same or different, independently represent a bond, a substituted or unsubstituted arylene, alkylene, aralkylene, or alkarylene group, —O—, —S—, —OR⁴—, —NR⁴—, —S(═O)—, —C(═O)—, —COO—, —OC(═O)—, —COO-ALK—OOC— wherein ALK is a branched or unbranched C2-C8 alkylene group (such as an ethylene, propylene, butylene, isobutylene, pentylene, hexylene, or neopentylene group), —CONR⁴—, —NR⁴C(═O)—, —SO₂—, —P(═O)₂O—, or —P(═O)₂(OR⁴)—; wherein R⁴ is a hydrogen or an alkyl or an aryl group. R² and R³, which can be the same or different, independently represent H, an alkyl group, an aryl group, —OR⁵, —NHR⁵, —N(R⁵)₂, or —SR⁵; wherein R⁵ is independently an alkyl group or an aryl group. X is the radically transferable atom or group, such as a halogen. Modified pigments having these attached groups may be prepared using any method known in the art. For example, a carbon product comprising at least one carboxylic acid group may be reacted with an hydroxyalkyl bromide to form a modified carbon product having an attached Br group. Alternatively, a pigment having attached at least one alcohol group may be reacted with a halogen-containing acylating agent. Additional methods of attaching radically transferable atoms or groups to carbon products are described in U.S. Pat. No. 6,664,312, which is hereby incorporated by reference in its entirety.

The modified pigments may be prepared using any method known to those skilled in the art such that organic chemical groups are attached to the pigment. Preferably, the modified pigment is prepared using the methods described in U.S. Pat. Nos. 5,554,739, 5,707,432, 5,837,045, 5,851,280, 5,885,335, 5,895,522, 5,900,029, 5,922,118, and 6,042,643, and PCT Publication No. WO 99/23174, the descriptions of which are fully incorporated herein by reference. Other methods for preparing the modified pigments include reacting a pigment having available functional groups with a reagent comprising the radically transferable atom or group. Such functional pigments may be prepared using the methods described in the references incorporated above. In addition carbon blacks containing functional groups may also be prepared by the methods described in U.S. Pat. Nos. 6,831,194 and 6,660,075, U.S. Pat. Publication Nos. 2003-0101901 and 2001-0036994, Canadian Patent No. 2,351,162, European Patent Nos. 1 394 221 and 1 586 607, and PCT Publication No. WO 04/63289, each of which is also incorporated in their entirety by reference herein.

The radical polymerization processes used to form the polymer modified pigment includes the use of at least one radically polymerizable monomer. Suitable radically polymerizable monomers used in the polymerization step comprise at least one diene group or at least one vinyl group. Examples include, but are not limited to, acrylic and methacrylic acid, acrylate esters, (meth)acrylate esters, acrylonitriles, cyanoacrylate esters, maleate and fumarate diesters, vinyl pyridines, vinyl N-alkylpyrroles, vinyl acetate, vinyl oxazoles, vinyl thiazoles, vinyl pyrimidines, vinyl imidazoles, allyl and vinyl ethers, vinyl ketones, and styrenes. Vinyl ketones include those in which the α-carbon atom of the alkyl group does not bear a hydrogen atom, such as vinyl ketones in which both α-carbons bear a C₁-C₄ alkyl group, halogen, etc. or a vinyl phenyl ketone in which the phenyl group may be substituted with from 1 to 5 C₁-C₆ alkyl groups and/or halogen atoms. Styrenes include those in which the vinyl group is substituted with a C₁-C₆ alkyl group, such as at the α-carbon atom, and/or those in which the phenyl group is substituted with from 1 to 5 substituents including a C₁-C₆ alkyl, alkenyl (including vinyl), or alkynyl (including acetylenyl) group, a phenyl group, a haloalkyl group, and functional groups such as C₁-C₆ alkoxy, halogen, nitro, carboxy, sulfonate, C₁-C₆ alkoxycarbonyl, hydroxy (including those protected with a C₁-C₆ acyl group), and cyano groups. Specific examples include methyl acrylate (MA), methyl methacrylate (MMA), butyl acrylate (BA), 2-ethylhexyl acrylate (EHA), acrylonitrile (AN), methacrylonitrile, styrene, and derivatives thereof.

In a preferred method for preparing the polymer modified pigments used in the inkjet ink compositions of the present invention, the concentration of modified pigment is low in the polymerization step in order to produce polymer modified pigments having improved properties, such as pigment dispersion stability. Preferably, the modified pigment is present in an amount of between about 1 and about 30 percent solids, more preferably between about 2 and about 20 percent solids, and most preferably between about 5 and about 10 percent solids. For example, the modified pigment may be dispersed in the polymerizable monomer or monomers for the polymerization step or in a mixture comprising the polymerizable monomer or monomers and at least one solvent, such as water, NMP, methanol, anisole, or other organic solvent or mixtures of solvents. Any ratio of monomer to solvent can be used. The total amount of monomer may be between about 1 % to about 99% by weight. The amount of monomer may also be varied depending on the amount of modified pigment used.

The radical polymerization process may further comprise the addition of at least one transition metal catalyst, which helps facilitate the transfer of the radically transferable atom or group during polymerization. Suitable transition metal catalysts include those comprising a transition metal and a ligand coordinated to the transition metal. For example, the transition metal may comprise copper, iron, rhodium, nickel, cobalt, palladium, or ruthenium with a suitable ligand. In some embodiments, the transition metal catalyst comprises a copper halide, such as Cu(I)Br or Cu(I)Cl. Any ligand known in the art may be used, depending upon the monomers used for the polymerization. Specific types of ligand useful when the monomer comprises an acidic group are described in more detail below.

In a preferred method for preparing the polymer modified pigments used in the inkjet ink compositions of the present invention, the amount of transition metal catalyst is adjusted in order to produce polymer modified pigments having improved properties, such as pigment dispersion stability. For example, it is preferred that ratio of the transferable atom or group to the amount of transition metal catalyst be between about 20:1 and about 500:1, more preferably between about 50:1 and about 400:1, and most preferably between about 100:1 and about 300:1.

As discussed above, the polymer modified pigments used in the inkjet ink compositions of the present invention are prepared by a “grafting from” polymerization method. In a second embodiment, the polymer modified pigment is prepared by a process comprising the step of polymerizing at least one ionically polymerizable monomer from a modified pigment comprising a pigment having attached at least one ionically transferable atom or group. This is also a “grafting from” process since the ionically polymerized monomer is polymerized “from” the modified pigment, and the modified pigment provides the initiation sites for the polymerization. An example of such a method includes GTP, discussed in more detail above. The term “ionically” includes cationically or anionically. For this embodiment, the pigment may be any of those described above. The transferable atom or group and the polymerizable monomer may be any of those described above that can be used for an ionic polymerization. For example, the transferable atom or group may comprise a silyl group, such as a trimethyl silyl group, and the polymerizable monomer may be an acrylate ester, methacrylate ester, or an alkyl vinyl ketone. Other monomers include those described, for example, U.S. Pat. No. 4,508,880, which is incorporated in its entirety by reference herein. The modified pigment may be prepared using any of the processes described above.

In a third embodiment, the polymer modified pigment used in the inkjet ink composition of the present invention is prepared by a process comprising the step of polymerizing at least one polymerizable monomer from a modified pigment comprising a pigment having attached at least one transferable atom or group. For this embodiment of a “grafting from” process, the polymerizable monomer comprises an ionizable group. Any of the polymerizable monomers described above that also comprise ionizable groups may be used including, for example, acrylic acid, methacrylic acid, vinyl pyridine, dimethylaminoethyl acrylate, dimethylaminoethyl methacrylate, and derivatives thereof. The ionizable groups may then be converted to ionic groups. Thus, the polymer modified pigment prepared by this process comprises a pigment having attached at least one ionic polymeric group.

For this embodiment, a transition metal catalyst is used in which the interactions of the catalyst with the reaction media and the reaction components do not prevent the catalyst from being active in the desired polymerization process. It may also be desirable for the transition metal catalyst to be at least partially soluble in the reaction media, being sufficiently solubility such that at least a portion of the transition metal complex of both oxidation states is soluble in the reaction media. Furthermore, the transition metal catalyst may also have a low redox potential (such as less than about 500 mV versus NHE); be stable towards ionic species, having an acidity stability constant of the protonated ligand greater than about 10⁻⁴; have a low propensity to disproportionation, with a conditional diproporportionation constant of less than about 1000; or have a sufficient conditional metal-radically transferable atom or group philicity to act as a catalyst in the reaction medium (such as greater than about 10). Preferably the transition metal catalyst has all of these properties. Suitable catalysts are described in N. Tsarevsky, B. McKenzie, W. Tang, and K. Matyjaszewski, Polymer Preprints, 46(2), 2005, 482-483, which is incorporated in its entirety by reference herein. For example, the transition metal catalyst may comprise a heterodonor ligand, which may be useful in catalytic reactions in aqueous, polar, acidic, ionic and basic media or with polar, acidic, ionic and basic monomers. The heterodonor ligand may be a bidentate or a multidentate ligand. In acidic media or other media which may protonate compounds, the heterodonor ligand may comprise a donor atom that cannot be protonated. The heterodonor ligand may have at least two donor atoms each independently selected from the group consisting of oxygen, sulfur, selenium, tellurium, nitrogen, phosphorus, arsenic, antimony, and bismuth. A specific examples of a useful heterodonor ligand is the sodium salt of ethylenedithiol diacetic acid. Useful transition metal catalysts are described in more detail in U.S. patent application Ser. No. 20040122189, which is incorporated in its entirety by reference herein.

For any of the polymerization processes described above that can be used to prepare the polymer modified pigment, the amount of attached polymeric groups can vary depending on a variety of factors, including the particle size of the modified pigment, and the type and class of polymer used, including its molecular weight. In general, an amount of polymer is present such that the total amount of polymer is greater than or equal to about 10 parts per hundred parts of pigment, such as greater than or equal to about 20 parts, 30 parts, or 40 parts per hundred parts of pigment, and is preferably less than or equal to about 1000 parts per hundred parts of pigment, such as less than or equal to 800 parts, 600 parts, 400 parts or 200 parts per hundred parts of pigment. In general, this represents higher levels of attached polymer than is typically produced by process described in the art.

In addition, for any of the polymerization processes described above, there are several preferred methods that include the use of specific types of polymerizable monomers. These are described in more detail below.

In one preferred method, at least one of the polymerizable monomers comprises a hydrophilic group which is not an ionic group. As used herein, an ionic group is either anionic or cationic and is associated with a counterion of the opposite charge. Examples of hydrophilic nonionic groups include, but are not limited to, ether, alcohol, and amide groups. Specific examples of polymerizable monomers comprising a hydrophilic nonionic group include 2-hydroxyethyl methacrylate (HEMA), 2-hydroxyethyl acrylate (HEA), N-vinyl pyrrolidone (NVP), N-vinyl acetamide (NVAc), acrylate and methacrylate esters comprising alkylene oxide groups (such as polyethylene glycol acrylate or methacrylate), and derivatives thereof. Thus, the polymeric group comprises at least one hydrophilic nonionic functional group. The hydrophilic nonionic group may be pendant to the backbone of the polymeric group. The pendant group may also be a polymeric group comprising the hydrophilic nonionic group.

Alternatively, the polymeric group comprising the hydrophilic nonionic group may also be prepared from at least one polymerizable monomer comprising a reactive group that can be converted to a hydrophilic nonionic group. Thus, the method may comprise the step of polymerizing at least one polymerizable monomer comprising at least one reactive group and further comprises the step of converting at least a portion of these reactive groups to a hydrophilic nonionic group. For example, the polymerizable monomer may comprise an acetoxy group, such as vinyl acetate, or an ether group, such as vinyl methyl ether, either of which can be converted to an alcohol group.

In a second preferred method, at least one of the polymerizable monomers comprises a reactive functional group which can be converted to a second group, such as an ionic group. Thus, the method comprises the step of polymerizing at least one polymerizable monomer comprising at least one reactive group and further comprises the step of converting at least a portion of these reactive groups to a second group. Examples of reactive groups include, but are not limited to, epoxy groups (which can be converted to a variety of second groups including diols), isocyanate groups (which can be converted to second groups such as amines, carbamates, ureas, and biurets), halomethyl styrene groups including a chloromethyl styrene group (which can be converted to second groups such as ammonium methyl styrenes or hydroxymethyl styrenes), activated ester groups including nitrobenzyl esters (which can be converted to carboxylic acids), and esters of sulfonic acids (which can be converted to sulfonic acids). Preferred are reactive groups that can be converted to an ionic group. The polymer modified pigment resulting from this preferred method therefore comprises ionic groups.

In one embodiment of this method, the reactive group is an ionizable group, including a cationizable group or an anionizable group. An ionizable group is one that is capable of forming an ionic group. Anionizable groups form anions and cationizable groups form cations. Converting the cationizable or anionizable group to the corresponding cationic or anionic group may be done using any method known in the art. For example, a reactive group that is cationizable may be converted to a cationic group either by quaternization (such as by reacting the cationizable group with an alkylating agent or other electrophile) or by protonation (such as by subjecting the cationizable group to pH's that are near or below the pK_{b} of the cationizable group). Thus, for example, the polymerizable monomer may comprise an amino group and the method further comprises converting the amino group to either a protonated or quaternized ammonium group. Specific examples of polymerizable monomers comprising a cationizable group include, but are not limited to, dimethylaminoethyl methacrylate (DMAEMA) and other dialkylaminoethyl methacrylates, dimethylaminoethyl acrylate (DMAEA) and other dialkylaminoethyl acrylates, 2-vinyl pyridine (2VP), 4-vinyl pyridine (4VP), and derivatives thereof. In addition, the ionizable group may be anionizable (such as a carboxylic acid or sulfonic acid group), which can then be converted to ionic groups (such as a carboxylate groups or sulfonate groups) by deprotonation. Examples of polymerizable monomers comprising anionizable groups include, but are not limited to, acrylic acid (AA), methacrylic acid (MAA), maleic acid, fumaric acid, itaconic acid, vinyl sulfonic acid, acrylamidomethylpropane sulfonic acid (AMPS), or styrene sulfonic acid.

In another embodiment of this method, the reactive group is an ester group that can be converted to an anionic group. Thus, for example, the reactive group may be an ester group that can be converted to the corresponding carboxylic acid group by hydrolysis and, under the conditions of hydrolysis, can form a carboxylate group. Examples of polymerizable monomers that comprise hydrolyzable ester groups include, but are not limited to, esters of acrylic and methacrylic acid, such as acrylate and. methacrylate esters of C₁-C₂₀ alcohols, maleic anhydride, and derivatives thereof. The reactive group may also be an ester group that can be converted to the corresponding acid group by dealkylation, which, under the conditions of hydrolysis, can form a carboxylate group. In this case, a preferred reactive ester group is a t-butyl ester group which can be converted to carboxylic acid salts under specific reaction conditions. Examples of polymerizable monomers that comprise reactive t-butyl groups include, but are not limited to, t-butyl methacrylate (tBMA), t-butyl acrylate (tBA), and derivatives thereof.

In a third preferred method, the modified pigment may comprise a pigment also having attached at least one non-transferable atom or group. Thus, the modified pigment may have both transferable and non-transferable atoms or groups. The methods described above for the preparing the modified pigments comprising at least one transferable atom or group can also be used here. The non-transferable group may have the same structure as shown above for the attached transferable group, however, without the transferable atom, such as an X group described above or a non-halogen containing alkyl group. Additional examples include groups comprising ionic or ionizable groups, such as carboxylic acid groups, sulfonic acid groups, or salts thereof, including —C₆H₄—COO⁻ and —C₆H4—SO₃⁻ groups. The presence of the non-transferable atom or group may enable control over the amount and distribution of the polymeric groups, which may then affect the overall performance of the polymer modified pigment in the disclosed inkjet ink compositions. Additional beneficial attributes may also result.

Any of the processes described above for preparing the polymer modified pigment may further comprise a purification step using a variety of available techniques. For example, the polymer modified pigment may be purified by washing, such as by filtration, centrifugation, or a combination of the two methods, to remove unreacted raw materials, byproduct salts and other reaction impurities. The polymer modified pigment may also be isolated, for example, by evaporation or may be recovered by filtration and drying using known techniques to those skilled in the art. In addition, the modified pigments may be dispersed in a suitable medium and purified to remove any undesired soluble free species. Known techniques of ultrafiltration/diafiltration using a membrane or ion exchange may be used to purify the dispersion and remove a substantial amount of free ionic and unwanted species. Other techniques will also be known to one skilled in the art.

For the inkjet ink compositions of the present invention, the polymer modified pigment may have either a preferred average particle size, a preferred type of polymeric group, or both. Thus, preferably the average particle size of the polymer modified pigment is less than or equal to about 1000 nm, more preferably less than or equal to about 500 nm, and most preferably less than or equal to about 350 nm in the inkjet ink composition. The average particle size is also preferably greater than about 10 nm, such as greater than about 20 nm, greater than about 30 nm, greater than about 40 nm, or greater than about 50 nm.

Alternatively, the inkjet ink composition preferably comprises a polymer modified pigment having an attached polymeric group which comprises at least one ionic group in an amount greater than or equal to about 0.05 mmoles of ionic groups per gram of polymer modified pigment. Preferably the amount of ionic group is greater than or equal to about 0.1 mmoles, and more preferably greater than or equal to about 0.3 mmoles of ionic groups per gram of polymer modified pigment. Also, the attached polymeric group preferably comprises at least one ionic group in an amount less than or equal to about 12 mmoles, preferably less than or equal to about 10 mmoles and more preferably less than or equal to about 6 mmoles, such as less than or equal to about 4 nunoles or ionic groups or less than or equal to about 2 mmoles of ionic groups per gram of polymer modified pigment. For example, the polymer modified pigment may have an attached polymer having anionic groups, such as carboxylic acid salt groups. In this case, the amount of anionic groups is sometimes referred to as the acid number for the polymer. Thus, if the attached polymer comprises acid groups, the polymer preferably has an acid number of greater than or equal to about 20, preferably greater than or equal about 40, more preferably greater than or equal to about 100, and most preferably greater than or equal to about 130. Also, the acid number is preferably less than or equal to about 800 and more preferably less than or equal to about 400. This value may be determined by any method known in the art, including, for example, titration.

The polymer modified pigments are present in the inkjet ink composition in an amount effective to provide the desired image quality (for example, optical density) without detrimentally affecting the performance of the inkjet ink. For example, typically, the polymer modified pigment will be present in an amount ranging from about 0.1 % to about 30%, including from about 0.5 % to about 20% and about 1 % to about 10%, based on the weight of the ink. This is, in general, higher than for conventional pigments. Thus, the inkjet ink composition can comprise higher levels of pigment by weight using the polymer modified pigment described herein than using conventional pigments due to the presence of the attached polymeric groups. More or less pigment may be used depending on the amount of attached polymer. It is also within the bounds of the present invention to use a formulation containing a mixture of the polymer modified pigments described herein and unmodified pigments, other modified pigments, (such as oxidized pigments as well as pigments having attached ionic or ionizable groups), or both.

The inkjet ink compositions of the present invention can be formed with a minimum of additional components (additives and/or cosolvents) and processing steps. However, suitable additives may also be incorporated into these inkjet ink compositions to impart a number of desired properties while maintaining the stability of the compositions. For example, surfactants (non-polymeric dispersants) may be added to further enhance the colloidal stability of the composition. Other additives are well known in the art and include humectants, biocides, binders, drying accelerators, penetrants, and the like. The amount of a particular additive will vary depending on a variety of factors but are generally present in an amount ranging between 0% and 40% based on the weight of the inkjet ink composition.

Additional dispersing agents (surfactants and/or polymeric dispersants that differ from those described above) may be added to further enhance the colloidal stability of the composition or to change the interaction of the ink with either the printing substrate, such as printing paper, or with the ink printhead. Various anionic, cationic and nonionic dispersing agents can be used in conjunction with the ink composition of the present invention, and these may be in solid form or as a water solution.

Representative examples of anionic dispersants or surfactants include, but are not limited to, higher fatty acid salts, higher alkyldicarboxylates, sulfuric acid ester salts of higher alcohols, higher alkyl-sulfonates, alkylbenzenesulfonates, alkylnaphthalene sulfonates, naphthalene sulfonates (Na, K, Li, Ca, etc.), formalin polycondensates, condensates between higher fatty acids and amino acids, dialkylsulfosuccinic acid ester salts, alkylsulfosuccinates, naphthenates, alkylether carboxylates, acylated peptides, α-olefin sulfonates, N-acrylmethyl taurine, alkylether sulfonates, secondary higher alcohol ethoxysulfates, polyoxyethylene alkylphenylether sulfates, monoglycylsulfates, alkylether phosphates and alkyl phosphates. For example, polymers and copolymers of styrene sulfonate salts, unsubstituted and substituted naphthalene sulfonate salts (e.g. alkyl or alkoxy substituted naphthalene derivatives), aldehyde derivatives (such as unsubstituted alkyl aldehyde derivatives including formaldehyde, acetaldehyde, propylaldehyde, and the like), maleic acid salts, and mixtures thereof may be used as the anionic dispersing aids. Salts include, for example, Na⁺, Li⁺, K⁺, Cs⁺, Rb⁺, and substituted and unsubstituted ammonium cations. Specific examples include, but are not limited to, commercial products such as Versa® 4, Versa® 7, and Versa® 77 (National Starch and Chemical Co.); Lomar® D (Diamond Shamrock Chemicals Co.); Daxad®19 and Daxad® K (W. R. Grace Co.); and Tamol® SN (Rohm & Haas). Representative examples of cationic surfactants include aliphatic amines, quaternary ammonium salts, sulfonium salts, phosphonium salts and the like.

Representative examples of nonionic dispersants or surfactants that can be used in ink jet inks of the present invention include fluorine derivatives, silicone derivatives, acrylic acid copolymers, polyoxyethylene alkyl ether, polyoxyethylene alkylphenyl ether, polyoxyethylene secondary alcohol ether, polyoxyethylene styrol ether, polyoxyethylene lanolin derivatives, ethylene oxide derivatives of alkylphenol formalin condensates, polyoxyethylene polyoxypropylene block polymers, fatty acid esters of polyoxyethylene polyoxypropylene alkylether polyoxyethylene compounds, ethylene glycol fatty acid esters of polyethylene oxide condensation type, fatty acid monoglycerides, fatty acid esters of polyglycerol, fatty acid esters of propylene glycol, cane sugar fatty acid esters, fatty acid alkanol amides, polyoxyethylene fatty acid amides and polyoxyethylene alkylamine oxides. For example, ethoxylated monoalkyl or dialkyl phenols may be used, such as Igepal® CA and CO series materials (Rhone-Poulenc Co.) Briji® Series materials (ICI Americas, Inc.), and Triton® series materials (Union Carbide Company). These nonionic surfactants or dispersants can be used alone or in combination with the aforementioned anionic and cationic dispersants.

The dispersing agents may also be a natural polymer or a synthetic polymer dispersant. Specific examples of natural polymer dispersants include proteins such as glue, gelatin, casein and albumin; natural rubbers such as gum arabic and tragacanth gum; glucosides such as saponin; alginic acid, and alginic acid derivatives such as propyleneglycol alginate, triethanolamine alginate, and ammonium alginate; and cellulose derivatives such as methyl cellulose, carboxymethyl cellulose, hydroxyethyl cellulose and ethylhydroxy cellulose. Specific examples of polymeric dispersants, including synthetic polymeric dispersants, include polyvinyl alcohols; polyvinylpyrrolidones; acrylic or methacrylic resins (often written as “(meth)acrylic”) such as poly(meth)acrylic acid, acrylic acid-(meth)acrylonitrile copolymers, potassium (meth)acrylate-(meth)acrylonitrile copolymers, vinyl acetate-(meth)acrylate ester copolymers and (meth)acrylic acid-(meth)acrylate ester copolymers; styrene-acrylic or methacrylic resins such as styrene-(meth)acrylic acid copolymers, styrene-(meth)acrylic acid-(meth)acrylate ester copolymers, styrene- -methylstyrene-(meth)acrylic acid copolymers, styrene- -methylstyrene-(meth)acrylic acid-(meth)acrylate ester copolymers; styrene-maleic acid copolymers; styrene-maleic anhydride copolymers, vinyl naphthalene-acrylic or methacrylic acid copolymers; vinyl naphthalene-maleic acid copolymers; and vinyl acetate copolymers such as vinyl acetate-ethylene copolymer, vinyl acetate-fatty acid vinyl ethylene copolymers, vinyl acetate-maleate ester copolymers, vinyl acetate-crotonic acid copolymer and vinyl acetate-acrylic acid copolymer; and salts thereof.

Humectants and water soluble organic compounds may also be added to the inkjet ink composition of the present invention, particularly for the purpose of preventing clogging of the nozzle as well as for providing paper penetration (penetrants), improved drying (drying accelerators), and anti-cockling properties. Specific examples of humectants and other water soluble compounds that may be used include low molecular-weight glycols such as ethylene glycol, diethylene glycol, triethylene glycol, tetraethylene glycol and dipropylene glycol; diols containing from about 2 to about 40 carbon atoms, such as 1,3-pentanediol, 1,4-butanediol, 1,5-pentanediol, 1,4-pentanediol, 1,6-hexanediol, 1,5- hexanediol, 2,6-hexanediol, neopentylglycol (2,2-dimethyl-1,3-propanediol, 1,3-propanediol, 1,4-butanediol, 1,5-pentanediol, 1,6-hexanediol, 1,2,6-hexanetriol, poly(ethylene-co-propylene) glycol, and the like, as well as their reaction products with alkylene oxides, including ethylene oxides, including ethylene oxide and propylene oxide; triol derivatives containing from about 3 to about 40 carbon atoms, including glycerine, trimethylpropane, 1,3,5-pentanetriol, 1,2,6-hexanetriol, and the like as well as their reaction products with alkylene oxides, including ethylene oxide, propylene oxide, and mixtures thereof; neopentylglycol, (2,2-dimethyl-1,3-propanediol), and the like, as well as their reaction products with alkylene oxides, including ethylene oxide and propylene oxide in any desirable molar ratio to form materials with a wide range of molecular weights; thiodiglycol; pentaerythritol and lower alcohols such as ethanol, propanol, iso-propyl alcohol, n-butyl alcohol, sec-butyl alcohol, and tert-butyl alcohol, 2-propyn-1-ol (propargyl alcohol), 2-buten-1-ol, 3-buten-2-ol, 3-butyn-2-ol, and cylcopropanol; amides such as dimethyl formaldehyde and dimethyl acetamide; ketones or ketoalcohols such as acetone and diacetone alcohol; ethers such as tetrahydrofurane and dioxane; cellosolves such as ethylene glycol monomethyl ether and ethylene glycol monoethyl ether, triethylene glycol monomethyl (or monoethyl) ether; carbitols such as diethylene glycol monomethyl ether, diethylene glycol monoethyl ether, and diethylene glycol monobutyl ether; lactams such as 2-pyrrolidone, N-methyl-2-pyrrolidone and ε-caprolactam; urea and urea derivatives; inner salts such as betaine, and the like; thio (sulfur) derivatives of the aforementioned materials including 1-butanethiol; t-butanethiol 1-methyl-1-propanethiol, 2-methyl-1-propanethiol; 2-methyl-2-propanethiol; thiocyclopropanol, thioethyleneglycol, thiodiethyleneglycol, trithio- or dithio-diethyleneglycol, and the like; hydroxyamide derivatives, including acetylethanolamine, acetylpropanolamine, propylcarboxyethanolamine, propylcarboxy propanolamine, and the like; reaction products of the aforementioned materials with alkylene oxides; and mixtures thereof. Additional examples include saccharides such as maltitol, sorbitol, gluconolactone and maltose; polyhydric alcohols such as trimethylol propane and trimethylol ethane; N-methyl-2-pyrrolidene; 1,3-dimethyl-2-imidazolidinone; sulfoxide derivatives containing from about 2 to about 40 carbon atoms, including dialkylsulfides (symmetric and asymmetric sulfoxides) such as dimethylsulfoxide, methylethylsulfoxide, alkylphenyl sulfoxides, and the like; and sulfone derivatives (symmetric and asymmetric sulfones) containing from about 2 to about 40 carbon atoms, such as dimethylsulfone, methylethylsulfone, sulfolane (tetramethylenesulfone, a cyclic sulfone), dialkyl sulfones, alkyl phenyl sulfones, dimethylsulfone, methylethylsulfone, diethylsulfone, ethylpropylsulfone, methylphenylsulfone, methylsulfolane, dimethylsulfolane, and the like. Such materials may be used alone or in combination.

Biocides and/or fungicides may also be added to the inkjet ink composition of the present invention. Biocides are important in preventing bacterial growth since bacteria are often larger than ink nozzles and can cause clogging as well as other printing problems. Examples of useful biocides include, but are not limited to, benzoate or sorbate salts, and isothiazolinones.

Various polymeric binders can also be used in conjunction with the inkjet ink composition of the present invention to adjust the viscosity of the composition as well as to provide other desirable properties. Suitable polymeric binders include, but are not limited to, water soluble polymers and copolymers such as gum arabic, polyacrylate salts, polymethacrylate salts, polyvinyl alcohols, hydroxypropylenecellulose, hydroxyethylcellulose, polyvinylpyrrolidinone, polyvinylether, starch, polysaccharides, polyethyleneimines with or without being derivatized with ethylene oxide and propylene oxide including the Discole® series (DKS International); the Jeffamine® series (Texaco); and the like. Additional examples of water-soluble polymer compounds include various dispersants or surfactants described above, including, for example, styrene-acrylic acid copolymers, styrene-acrylic acid-alkyl acrylate terpolymers, styrene-methacrylic acid copolymers, styrene-maleic acid copolymers, styrene-maleic acid-alkyl acrylate terpolymers, styrene-methacrylic acid-alkyl acrylate terpolymers, styrene-maleic acid half ester copolymers, vinyl naphthalene-acrylic acid copolymers, alginic acid, polyacrylic acids or their salts and their derivatives. In addition, the binder may be added or present in dispersion or latex form. For example, the polymeric binder may be a latex of acrylate or methacrylate copolymers or may be a water dispersible polyurethane.

Various additives for controlling or regulating the pH of the inkjet ink composition of the present invention may also be used. Examples of suitable pH regulators include various amines such as diethanolamine and triethanolamine as well as various hydroxide reagents. An hydroxide reagent is any reagent that comprises an OH⁻ ion, such as a salt having an hydroxide counterion. Examples include sodium hydroxide, potassium hydroxide, lithium hydroxide, ammonium hydroxide, and tetramethyl ammonium hydroxide. Other hydroxide salts, as well as mixtures of hydroxide reagents, can also be used. Furthermore, other alkaline reagents may also be used which generate OH⁻ ions in an aqueous medium. Examples include carbonates such as sodium carbonate, bicarbonates such as sodium bicarbonate, and alkoxides such as sodium methoxide and sodium ethoxide. Buffers may also be added.

Additionally, the inkjet ink composition of the present invention may further incorporate dyes to modify color balance and adjust optical density. Such dyes include food dyes, FD&C dyes, acid dyes, direct dyes, reactive dyes, derivatives of phthalocyanine sulfonic acids, including copper phthalocyanine derivatives, sodium salts, ammonium salts, potassium salts, lithium salts, and the like. It is also within the bounds of the present invention to use a mixture of the pigments described herein and modified pigments, such as modified pigments comprising pigments having attached at least one organic group. The modified pigments can be prepared using the methods described in U.S. Pat. Nos. 5,554,739, 5,707,432, 5,837,045, 5,851,280, 5,885,335, 5,895,522, 5,900,029, 5,922,118, and 6,042,643, and PCT Publication WO 99/23174, the descriptions of which are fully incorporated herein by reference.

The inkjet ink composition can be purified and/or classified using methods such as those described above for the polymer modified pigments. In this way, unwanted impurities or undesirable large particles can be removed to produce an ink with good overall properties. However, it may also be advantageous, when purifying the inkjet ink compositions, to remove some, but not all, of the impurities. This is particularly true for removal of any polymeric material formed that is not attached to the pigment. Unattached polymer may function as a useful additive, such as those described above, and, in some cases can be left in the ink compositions. Thus, the level of purification may be dictated by the desired ink performance properties. In addition, an optional exchange of counterions step may also occur in the purification process whereby the counterions that may form a part of the modified pigment are exchanged or substituted with alternative counterions (including, e.g., amphiphilic ions) utilizing known ion exchange techniques such as ultrafiltration, reverse osmosis, ion exchange columns and the like. Particular examples of counterions that can be exchanged include, but are not limited to, Na⁺, K⁺, Li⁺, NH₄⁺, Ca²⁺, Mg²⁺, Cl⁻, NO₃⁻, NO₂⁻, acetate, and Br⁻.

The present invention will be further clarified by the following examples which are intended to be only exemplary in nature.

### EXAMPLES

### Examples 1-3

Modified Pigment Preparation

The following examples describe the preparation of modified pigments having attached at least one radically transferable group.

### Example 1

A modified magenta pigment was prepared by combining Pigment Red 122 (179 g, 28% solids, available from Sun Chemicals), water (271. g), aminobenzyl alcohol (4.92 g, available from Aldrich Chemical Company), and methane sulfonic acid (13.72 g of a 70% solids aqueous solution available from Aldrich) under high shear mixing conditions using a rotor-stator mixer while heating to 70° C. When the temperature had stabilized, a solution of 2.76 g sodium nitrite dissolved in 25 g water was added over 25 minutes. The temperature was maintained for 1 hour after the addition was complete, and then the mixture was cooled. The resulting pigment comprising attached alcohol groups was collected by filtration, and washed with water once, and isopropanol twice, before drying in a vacuum oven at 80° C. for 18 hours with a nitrogen bleed.

The dried pigment (14 g) was then combined with 100 g tetrahydrofuran in a three-neck round-bottom flask equipped with an addition funnel and subjected to vigorous agitation using a rotor-stator agitator. Triethylamine (6.1 g) was added to the reaction vessel in one aliquot. In a separate container, 2-bromoisobutyrylbromide (9.3 g) and propionyl bromide (2.8 g) were combined and charged to the addition funnel. The mixed acid bromides were then added to the reaction vessel over 20 minutes, and the reaction temperature was maintained between 30 and 40° C. After the addition was complete, the reaction temperature was raised to 55° C. and the reaction was allowed to continue for another four hours. After this time, the reaction mixture was allowed to cool to room temperature. The resulting modified magenta pigment was collected by centrifugation and washed twice with tetrahydrofuran, once with isopropanol, and twice with water.

A small amount of the modified magenta pigment was dried in a vacuum oven at 65° C. for 18 hours with a nitrogen bleed and then washed with deuterium oxide. The deuterium oxide was analyzed by 1H NMR for the presence of ethyl groups, which are indicative of remaining triethylammonium hydrobromide. The modified pigment was washed with water until no ethyl groups were found in the D₂O washings. The amount of bromine was then determined by elemental analysis of the modified pigment, indicating the amount of attached bromo groups. Results are shown in Table 1 below.

### Example 2

A modified magenta pigment was prepared using the procedure described in Example 1, except using the ratio of acid bromides shown in Table 1 below. Results for the amount of bromine are also shown.

### Example 3

A modified magenta pigment was prepared using the procedure described in Example 1, except using the ratio of acid bromides shown in Table 1 below. Results for the amount of bromine are also shown.

TABLE 1

| | Molar ratio of | |
|---|---|---|
| | 2-bromoisobutyrylbromide to | |
| Example No. | propionyl bromide | % Br |
| 1 | 2:1 | 2.74 |
| 2 | 1:2 | 1.23 |
| 3 | 2-bromoisobutyrylbromide | 3.61 |

### Examples 4-5

Preparation of Polymer Modified Pigments

The following examples describe the preparation of polymer modified pigments using a “grafting from” polymerization process.

For each of these examples, the amount of attached polymer was determined by comparing the UV/Vis absorbance of the polymer modified pigment in a dispersion of a known concentration (% solids) to that of a dispersion of the starting pigment at the same concentration (% solids), using a wavelength where the pigment absorbs. The extinction coefficient for both the pigment of the polymer modified pigment and the starting pigment will be the same. Since both dispersions are at the same concentration, any decrease in absorbance must be due to a difference in the actual amount of pigment in the polymer modified pigment dispersion. This difference is the amount of polymer present and are reported as parts per hundred pigment (pph pigment). For the magenta pigment used in these examples, a wavelength of 533 nm was chosen for absorbance measurements on the UV/Vis Spectrophotometer.

Example 4

The modified magenta pigment of Example 1 (4 g) was dispersed in 40 g of hydroxyethyl acrylate and 11 g of anisole, with sonication. This mixture was then purged with nitrogen for 30 minutes. In a separate vessel, N, N, N′, N′, N″-pentamethyldiethylenetriamine (0.027) g and anisole (0.195 g) were combined and purged for 30 minutes with nitrogen. To this purged mixture was added 0.022 g copper (I) bromide. When the purging had been completed for both mixtures, the copper mixture was added to the pigment mixture by syringe. The reaction was stirred with a magnetic stirred at 90° C. under nitrogen for 23 hours.

The resulting reaction mixture, comprising a polymer modified magenta pigment, was dispersed in an equal amount of distilled water by sonication until the average particle size was less than 250 nm. The excess water, solvent and monomer were removed by diafiltration sequentially using 10 volumes of a 50 mM NaCl solution, 30 volumes of a 20% solution of n-propanol in water, 150 volumes of water, 30 volumes of a 20% solution of n-propanol in water, and 80 volumes of water until the dispersion had a surface tension of greater than 60 dynes/cm². The amount of attached polymer was determined using the procedure described above, and the results are shown in Table 2 below. The average particle size of the resulting polymer modified magenta pigment in the dispersion was found to be 199 nm (measured using a Microtrac UPA 150).

### Example 5

A polymer modified pigment was prepared using the procedure describe in Example 4, except using the modified magenta pigment described in Example 2. The resulting reaction mixture, comprising a polymer modified magenta pigment, was diluted to 1L (about 1 % solids) and then concentrated back to 200 mL by diafiltration. Diafiltration was then continued using 10 volumes of a 5 % solution of n-propanol in water followed by 20 volumes of water. The amount of attached polymer was determined using the procedure described above, and the results are shown in Table 2 below. The average particle size of the resulting polymer modified magenta pigment in the dispersion was found to be 246 nm (measured using a Microtrac UPA 150).

TABLE 2

| Example No. | Polymer type | Amount of polymer |
|---|---|---|
| 4 | Polyhydroxyethyl acrylate | 78 pph |
| 5 | Polyhydroxyethyl acrylate | 34 pph |

### Examples 6-7

Preparation of Inkjet Ink Compositions

The following examples describe the preparation of inkjet ink compositions of the present invention using polymer modified pigments prepared by a “grafting from” polymerization process.

### Example 6

A premix was made by combining 5 parts triethylene glycol monobutyl ether, 10 parts glycerine and 1 part Surfynol 465 (available from Air Products). An amount of the polymer modified pigment dispersion of Example 4 to give 4 wt% pigment was weighed out. To this was added the following components, in amounts to yield an inkjet ink composition with the corresponding weight percents: water (balance), triethylene glycol monobutyl ether (5 wt %) glycerine (10 wt %), Surfonyl 465 (1 wt %). The average particle size of the polymer modified pigment in the inkjet ink composition was found to be 185 nm, as measured using a Microtrac UPA 150.

### Example 7

An inkjet ink composition was prepared using the procedure described in Example 7, using the polymer modified pigment dispersion of Example 5. The average particle size of the polymer modified pigment in the inkjet ink composition was found to be 160 nm, as measured using a Microtrac UPA 150.

### Comparative Example 1

A comparative modified magenta pigment was prepared using Pigment Red 122, aminophenylsulfoethylsulfonate, and pentaethylhexamine according to Example 1 of U.S. Pat. No. 6,723,783, which is incorporated in its entirety by reference herein. This pigment having attached amine groups (437 g of 16.03% solids) was diluted to 6.7 % solids with 610 g water. This dispersion was agitated with high shear mixing using a rotor-stator mixer and heated to 65° C. The pH the dispersion was adjusted to 8.1 using an aqueous sodium hydroxide solution.

An acrylic acid/butyl acrylate/benzyl acrylate/itaconic anhydride copolymer (30% acrylic acid, 62.5% butyl acrylate, 5% benzyl acrylate and 2.5% itaconic anhydride) was prepared using semi-continuous feed techniques at 50% solids in methyl isobutylketone (MIBK). Dodecanethiol (4% based on the monomer feed) was added to the mixed monomers, and the mixture was fed into the solvent over 170 minutes, with the temperature being held between 85 and 95° C. Benzoyl peroxide (3 % based on the monomer feed) was dissolved in another 5 % of MIBK and added as a cofeed over the same period of time. The reaction temperature was maintained for an hour after the feed ended, and another aliqout of benzoyl peroxide, equal to the first, was added at the end of the hour. The polymer was collected by precipitation into hexanes twice, and then dissolved in tetrahydrofuran (approximately 10-20% solids). The inherent viscosity of the polymer was 0.10 dL/g in THF, and the acid number was 229 mg KOH/g polymer.

The tetrahydrofuran solution of the acrylic copolymer was poured into an aqueous alkaline solution prepared by dissolving 6.96 g sodium hydroxide in 379.2 g water and mixed thoroughly. The tetrahydrofuran was then removed by rotary evaporation, forming an aqueous acrylic copolymer solution.

The aqueous solution of polymer was added to the heated magenta pigment dispersion. The reaction mixture was held at 60° C. for three hours, and the pH was adjusted as needed to maintain a pH of between 8 and 9. At the end of the third hour, the pH was adjusted to 10.18 using an aqueous sodium hydroxide solution, and the mixture was stirred for another hour before cooling to 25° C. The cooled mixture was diafiltered with 10 volumes of 0.1M sodium hydroxide and then with water until the conductivity of the permeate was 150 microseimens. The final dispersion, which comprised a polymer modified magenta pigment not prepared by a “grafting from” polymerization process, was concentrated to 12.06% solids by diafiltration. The amount of attached polymer was determined to be 10.4 pph using the procedure described above. The average particle size of the resulting polymer modified magenta pigment in the dispersion was found to be 235 nm (measured using a Microtrac UPA 150).

An inkjet ink composition was prepared using the procedure described in Example 7, using this comparative polymer modified pigment dispersion.

### Example 8

Print Performance

This example describes the properties of images produced by printing the inkjet ink compositions of the present invention.

The inkjet inks of Examples 6-7 and Comparative Example 1 were individually charged to an Epson-compatible ink cartridge (Inkjetwarehouse.com, part number E-0431-K). Each ink was then printed from an Epson C86 printer onto Canon Photo Paper Pro paper. The resulting images were evaluated for visual appearance, including gloss. Also, images resulting from printing of Cab-O-Jet® 260M colored pigment dispersion (a magenta pigment dispersion commercially available from Cabot Corporation) under similar conditions were also determined. The results showed that the inkjet inks of the present invention had improved gloss appearance over those of both Comparative Example 1 and Cab-O-Jet® 260M.

### Example 9

A polymer modified magenta pigment, prepared by combining the modified magenta pigment of Example 1 (4 g), 40 g of vinyl pyrrolidone, and 11 g of anisole using the procedure described in Example 4, except that the polymerization time would be adjusted to reflect the higher reactivity of vinyl pyrrolidone, would be expected to produce inkjet ink compositions having similar performance as those of Examples 6 and 7.

### Example 10

A polymer modified magenta pigment, prepared by combining the modified magenta pigment of Example 1 (4 g), 40 g of acrylamide, and 11 g of anisole using the procedure described in Example 4, except that the polymerization time would be adjusted to reflect the higher reactivity of acrylamide, would be expected to produce inkjet ink compositions having similar performance as those of Examples 6 and 7.

### Example 11

Black Pearls® 700 carbon black (500 g) and p-aminobenzoic acid (137.14 g available from Aldrich Chemical Company) in 920 g deionized water were combined in a ProcessAll 4HV Mixer (4 liter). The mixture was heated to 50-55° C. and mixed at 300 RPM for 10 minutes. To this was added a solution of 69 g NaNO₂ dissolved in 207 mL of water over 10-15 minutes. The resulting mixture was heated to 60° C. for 2 hours. The contents were removed by dilution with water to a final concentration of about 15% (by weight) solids and then purified by centrifugation and diafiltration with 7.5 volumes of water. The resulting product was a dispersion of a black pigment having attached carboxylic acid salt groups (0.52 mmol/g).

15g of this dispersion was acidified to pH 2 to precipitate the carbon black pigment. This was filtered, washed with DI water and centrifuged several times, and finally dried under vacuum at 60° C. for 12 hours to form a dry powder of a carbon black having attached carboxylic acid groups.

The dry pigment was homogenized using a rotor-stator mixer in 250 mL of dry THF. To this dispersion was added 16 g of dicylcohexyl carbodiimide (DCC), 2.5 g of N,N-dimethylamino pyridine (DMAP), and 19.4 g of 2, 2-dimethyl-3-hydroxypropyl α-bromoisobutyrate, which was prepared using the procedure described by Newman, M. S. and Kilbourn, E. in J. Org. Chem. 1970, 35, 3186-3188. The reaction was homogenized for 5 hours and allowed to proceed overnight while stirring by a magnetic stir bar. The resulting pigment, which was a modified carbon black pigment having attached at least one radically transferable groups (in this case, a halogen group), was then purified by multiple centrifugations in THF.

The modified carbon black pigment (1.20 g, 0.238 mmol, 0.198 mmol Br/g carbon black), CuBr₂ (0.5 mL stock solution in anisole, 0.0143 mmol), pentamethyldodecanetriamine (PMDETA, 100 μL, 0.476 mmol), n-butyl acrylate (BA, 11.3 g, 0.088 mol), and anisole (8 mL) were added into a Schlenk flask and degassed using three freeze-pump-thaw cycles. CuBr (97%, available from Aldrich Chemical Company) was purified by stirring over glacial acetic acid, filtering, washing of the solid three times with ethanol and twice with diethyl ether, and vacuum-drying overnight. This purified CuBr (0.068 g, 0.476 mmol) was then added to the flask while the contents were frozen and protected under nitrogen. The polymerization was allowed to proceed for 12.5 hours at 70° C. to a conversion of 7 wt % of BA, as measured by GC. The resulting polymer modified carbon black pigment was isolated and purified by eight cycles of sonication and centrifugation. This polymer modified pigment, having an attached polybutylacrylate group, formed a dispersion in THF and had an average particle size of 182 nm (measured using a Microtrac UPA 150) in the dispersion. The polymer modified pigment was found to have a volatiles content (measured by TGA) of 25%.

The poly(n-BA)-modified carbon black was then used to initiate the polymerization of t-BA. The polymer modified pigment (0.76 g) was dried under vacuum at 55° C. for 12 hours and was then dispersed in anisole (4 mL) by sonication in an ice/water ultrasonic bath for half an hour. t-Butylacrylate (t-BA, 5.65 g, 0.044 mmol) and CuBr₂ (0.25 mL stock solution in anisole, 0.00714 mmol) were added, and the mixture was sonicated for another five minutes under nitrogen. After the addition of PMDETA (50 μL, 0.238 mmol), the dispersion was subjected to a freeze-pump-thaw cycle before CuBr (0.034 g, 0.238 mmol) was added under nitrogen. The polymerization was allowed to run for 60 hours at 70° C., and the materials were purified as described above for polymerizing n-BA. The resulting product, which is a polymer modified carbon black pigment having attached a block copolymer of n-BA and t-BA, formed a dispersion in THF and had an average particle size of 302 (measured using a Microtrac UPA 150). The polymer modified pigment was found to have a volatiles content (measured by TGA) of 76%.

The block copolymer-modified carbon black pigment (0.5 g) was dealkylated by placing it in a solution of 1.14 g trifluoroacetic acid dissolved in 20 mL THF overnight. The resulting polymer-modified carbon black was dispersible in water under basic conditions and had an average particle size in the dispersion of 325 nm (measured using a Microtrac UPA 150). The dried pigment was found to have a volatiles content of 65% (measured by TGA).

### Example 12

A polymer modified magenta pigment, could be prepared by combining the modified magenta pigment of Example 1 (6 g), 20 g of butyl acrylate, 20 g of t-butyl acrylate (which is a polymerizable monomer comprising a reactive functional group), and 11 g of anisole using the procedure described in Example 4, except that the polymerization time would be adjusted to reflect the lower reactivity of acrylate esters. The resulting mixture could then be added to sulfolane and heated to 165 ° C., to convert at least a portion of the reactive functional groups to ionic groups (carboxylic acid salt groups). The polymer modified pigment, which would be expected to have an acid number of about 280, could be dispersed in alkaline water and purified and would be expected to produce inkjet ink compositions having good durability on plain paper.

### Example 13

A polymer modified magenta pigment could be prepared using the procedure described in Example 12, except using 32 g of butyl acrylate and 16 g of t-butyl acrylate. The resulting polymer modified pigment, which would be expected to have an acid number of about 170, could be dispersed in alkaline water and purified and would be expected to produce inkjet ink compositions having good durability on plain paper.

### Example 14

A polymer modified magenta pigment could be prepared using the procedure described in Example 12, except using 32 g of butyl acrylate and 12 g of t-butyl acrylate. The resulting polymer modified pigment, which would be expected to have an acid number of about 130, could be dispersed in alkaline water and purified and would be expected to produce inkjet ink compositions having good durability on plain paper.

### Example 15

A polymer modified magenta pigment could be prepared using the procedure described in Example 12, except using 44 g of butyl acrylate and 8 g of t-butyl acrylate. The resulting polymer modified pigment, which would be expected to have an acid number of about 70, could be dispersed in a non-aqueous medium to produce a non-aqueous inkjet ink composition having good overall properties.

### Example 16

A polymer modified magenta pigment, could be prepared by combining the modified magenta pigment of Example 1 (6 g), 40 g of vinyl pyridine (which is a polymerizable monomer comprising a reactive functional group), and 11 g of anisole using the procedure described in Example 4, except that the polymerization time would be adjusted to reflect the higher reactivity of vinyl pyridine. At least a portion of the reactive functional groups could be converted to ionic groups (pyridinium salts) by dispersing in acidic water and purified, and this would be expected to produce inkjet ink compositions having good overall properties.

### Example 17

A dispersion of a black pigment having attached carboxylic acid salt groups was prepared as described in Example 11. 5 g of this dispersion was acidified to pH 2 to precipitate the carbon black. This was filtered, washed with DI water and centrifuged several times, and finally dried under vacuum at 60° C. for 12 hours to form a dry powder of a carbon black having attached carboxylic acid groups. The dry carbon black was homogenized using a rotor-stator mixer in 20mL of dry THF. To this dispersion was added 20 mL of SO₂Cl. After excess SO₂Cl and solvent were removed under vacuum, 3.3 g of 2,2-dimethyl-3-hydroxypropyl α-bromoisobutyrate, which was prepared using the procedure described by Newman, M. S. and Kilbourn, E. in J. Org. Chem. 1970, 35, 3186-3188, and 4.60 g of butoxyethanol in 40 mL of THF was added. The reaction was homogenized for 5 hours before the homogenizer was switched to a magnetic stir bar and allowed to proceed overnight while stirring. The resulting material was then purified by multiple centrifugations in THF.

A modified carbon black pigment having attached at least one halogen group was prepared as described in Example 11. The modified carbon black (0.58 g, 0.15 mmol) was added into a Schlenk flask and dried under a vacuum at room temperature for one hour. Dimethylaminoethyl methacrylate (DMAEMA, 11.8 g, 75 mmol), methanol (11 g), water (1.4 g), dimethylformamide (1.0 mL), bipyridine (0.15 g, 0.96 mmol), and CuBr₂ (0.040 g, 0.18 mmol) were then added to the Schlenk flask. The flask was then degassed by four freeze-pump-thaw cycles. While the contents were frozen in liquid nitrogen, the flask was backfilled with nitrogen and CuBr (0.043 g, 0.3 mmol), which was purified as described in Example 11, was added. The flask was then degassed and backfilled with nitrogen twice, then allowed to warm up to room temperature, and an initial sample was collected by syringe. The flask was then placed in an oil bath maintained at 30° C. to begin the polymerization. Samples were taken out of the flask periodically. Conversion of the monomer was monitored by both NMR and GC, and the polymerization was stopped at 18 hours. The resulting polymer modified carbon black pigment was isolated by ten cycles of sonication (redispersion) in methanol and centrifugation at 39,000 g for two hours. This process was repeated until no free polymer was detectable in the supernatant by GPC. The resulting poly-DMAEMA modified carbon black pigment was found to have a volatiles level of 58% by weight (measured by TGA) and formed a dispersion in methanol having an average particle size of 342 nm.

The dry polymer-modified carbon black formed a stable dispersion in water under acidic conditions. Thus, a small amount of the material was dispersed in water at pH 2 by sonication and had an average particle size of 462 nm in the dispersion (measured using a Microtrac UPA 150).

The poly-DMAEMA modified carbon black pigment (0.5 g) was dispersed in 20 mL of THF by sonication and was treated with 10 mL of ethylbromide. The mixture was allowed to stir overnight at room temperature, during which time product precipitated. The precipitated material was isolated by evaporating the solvent and excess alkyl halide. The resulting material, which was a polymer modified pigment having attached quaternary ammonium groups, was found to have a volatiles level of 74% (measured by TGA) and was dispersible in water, having an average particle size of 683 nm in the aqueous dispersion (measured using a Microtrac UPA 150). The degree of quaternization was also calculated from the NMR integrations of the methyl groups of the unquaternized amine and the methylene units in the polymer backbone, and was found to be 67%.

### Comparative Example 2

A polymer modified pigment, prepared following the procedure described in Example 1 of U.S. Pat. No. 6,664,312, except using Cab-O-Jet® 300 colored pigment dispersion (an aqueous dispersion of a modified carbon black pigment having attached CO₂Na groups commercially available from Cabot Corporation) and using hydroxyethyl acrylate in place of 2-dimethylaminoethyl methacrylate, and treated as for Example 4, would be expected to have an average particle size larger than 500 nm.

### Comparative Example 3

A polymer modified pigment, prepared following the procedure described in Example 1 of U.S. Pat. No. 6,664,312, except that the filtration steps shown were replaced by centrifugation. Thus, the resulting polymer modified carbon black, having attached poly-(2-dimethylamino)ethyl methacrylate, was centrifuged and washed with MeOH. This material was found to form a very poor aqueous dispersion, upon attempted redispersion in water. The product was then sonicated and soxhlet extracted as described in the cited example. After drying to remove MeOH, the resulting powder was also found to form a very poor aqueous dispersion, upon attempted redispersion in water, with multi-modal distributions, an average particle size of 1334 nm, and with visible undispersed material, making it unsuitable, as produced, as an inkjet ink.

### Examples 18-20

Modified Pigment Preparation

The following examples describe the preparation of modified pigments having attached at least one radically transferable group.

### Example 18

Modified Pigment Preparation

A modified magenta pigment having attached alcohol groups was prepared using a procedure similar to that described in Example 1. The dried pigment (14 g) was then combined with 100 g tetrahydrofuran in a three-neck round-bottom flask equipped with an addition funnel and subjected to vigorous agitation using a rotor-stator agitator. Triethylamine (6.1 g) was added to the reaction vessel in one aliquot. In a separate container, 2-bromoisobutylbromide (9.3 g) and propionyl bromide (2.8 g) were combined and charged to the addition funnel. The mixed acid bromides were then added to the reaction vessel over 20 minutes, and the temperature was maintained between 30 and 40° C. After the addition was complete, the reaction temperature was raised to 55° C., and the reaction was allowed to continue for another four hours. After this time, the reaction mixture was allowed to cool to room temperature. The resulting modified magenta pigment was collected by centrifugation, and washed twice with tetrahydrofuran, once with isopropanol, and twice with water.

A small amount of the modified magenta pigment was dried in a vacuum oven at 65° C. for 18 hours with a nitrogen bleed and then washed with deuterium oxide. The deuterium oxide was analyzed by 1H NMR for the presence of ethyl groups, which are indicative of remaining triethylammonium hydrobromide. The modified pigment was washed with water until no ethyl groups were found in the D₂O washings. The amount of bromine was then determined by elemental analysis of the modified pigment, indicating the amount of attached bromo groups. Results are shown in Table 3 below.

### Example 19

A modified magenta pigment was prepared using the procedure described in Example 18, except using the ratio of acid bromides shown in Table 3 below. Results for the amount of bromine are also shown.

### Example 20

A modified magenta pigment was prepared using the procedure described in Example 18, except using the ratio of acid bromides shown in Table 3 below. Results for the amount of bromine are also shown.

TABLE 3

| | Molar ratio of | |
|---|---|---|
| | 2-bromoisobutyrylbromide to | |
| Example No. | propionyl bromide | % Br |
| 18 | 2:1 | 2.74 |
| 19 | 1:2 | 1.23 |
| 20 | 2-bromoisobutylbromide | 3.61 |

### Example 21

Preparation of a Polymer Modified Pigment

The modified magenta pigment of Example 19 (5 g) was combined with 36 g methanol, 11.5 g ethylene glycol, 20.4 g methacrylic acid and 20.3 g 2-ethylhexylmethacrylate in a round bottom flask with sonication and purged with nitrogen for 30 minutes. The temperature of the mixture was then brought up to 70° C. In a separate vessel, 0.245 g of ethylenedithiol diacetic acid, sodium salt and 4.5 g of water were combined with stirring and purged with nitrogen. Into a third vessel was added 0.069 g of Cu(I)Br, and the atmosphere was purged with nitrogen. When the ethylenedithiol diacetic acid, sodium salt, had dissolved, it was added to the Cu(I)Br. This was warmed to about 50° C. with stirring, during which the Cu(I)Br dissolved. Once dissolved, the resulting solution was added in a steady stream over 1-2 minutes by syringe to the purged monomer mixture at 70° C. The reaction was monitored by GC over the course of 65 hours, and, after this time, the reaction was cooled to room temperature. The average particle size of the resulting reaction mixture, which comprised a polymer modified magenta pigment, was found to be 576 nm (measured using a Microtrac UPA 150).

The reaction mixture was diluted 1:1 with methanol, and sonicated for 10 minutes, after which the average particle size was found to be 131 mn. This was further diluted to 1% solids with methanol, and concentrated to 150 mL by diafiltration. The mixture was further purified by diafiltration sequentially with 10 volumes of 80/20 methanol/50 mM aqueous NaOH solution followed by 10 volumes of water. The particle size of the resulting polymer modified magenta pigment in the dispersion (3.4% solids) was found to be 254 nm (measured using a Microtrac UPA 150) with a surface tension of 61.8 dynes/cm². The amount of attached polymer, determined using the procedure described in Examples 4 and 5 above, was found to be 37% polymer by weight.

The polymer modified magenta pigment dispersion was concentrated to 13.6% solids and was used to prepare an inkjet ink composition of the present invention following the procedure described in Examples 6 and 7 above. The ink was printed following the procedures shown in Example 8, resulting in images having high color (high saturation) on plain paper.

### Example 22

A polymer modified magenta pigment was prepared using the procedure described in Example 21, except using 30 g of 2-ethylhexyl methacrylate and 10 g of methacrylic acid were used. The average particle size of the resulting polymer modified magenta pigment in the dispersion (19.67% solids) was found to be 167 nm (measured using a Microtrac UPA 150). The amount of attached polymer, determined using the procedure described in Examples 4 and 5 above, was found to be 58% polymer by weight.

### Example 23

A modified magenta pigment having attached aminobenzyl groups was prepared using a procedure similar to that described in U.S. Pat. Publication No. 2003-0195291 A1 as well as in Example 11 above, using Pigment Red 122 (available from Sun Chemicals) and aminobenzyl amine (12 mmoles used per gram of magenta pigment). The resulting modified magenta pigment dispersion (143 g, 10 g of modified pigment) was stirred in a 1 L beaker with an overhead mixer. To this was added, over 15 minutes, 27.6 g of 2-bromoisobutyryl bromide. During the addition, 10% sodium hydroxide solution was added as needed to maintain the pH at 8-9. After the addition, the reaction mixture was allowed to stir for thirty minutes, then isolated with a fritted glass funnel. The dispersion was washed repeatedly with water until the filtrate was not cloudy when treated with AgNO_{3,} indicating there was no free sodium bromide. This resulting product was found to have 3.8% bromine by weight, measured by combustion analysis.

This modified magenta pigment was used to prepare a polymer modified magenta pigment using the procedure described in Example 22. The average particle size of the resulting polymer modified magenta pigment in the dispersion (27.8% solids) was found to be 203 nm (measured using a Microtrac UPA 150). The amount of attached polymer, determined using the procedure described in Examples 4 and 5 above, was found to be 80% polymer by weight.

### Example 24

A modified carbon black having attached sulfonic acid salts groups and benzylamine groups was prepared using a procedure similar to that described in Example 1 above, using Black Pearls® 700 carbon black (available from Cabot Corporation). In a first step, sulfanilic acid (72 mmoles used per gram of carbon black) was used, and, in a second step, in the same vessel without further purification, amino benzylamine (2 mmoles per gram of carbon black) was used. The resulting modified carbon black dispersion (500 g, 93.7 g of pigment) was combined with 140 g of 2-bromoisobutyryl bromide, using the procedure described in Example 23 above. The dispersion was purified by diafiltration with water until the permeate was not cloudy when treated with AgNO_{3,} indicating there was no free sodium bromide. The resulting modified carbon black product was found to have 3.41% bromine by weight measured by combustion analysis.

### Example 25

A modified carbon black product was prepared using the procedure described in Example 24 above, except that a mixture of 2-bromoisobutyryl bromide (70.3 g) and proprionyl bromide (70.3 g) was used. The resulting modified carbon black product was found to have 2% bromine by weight measured by combustion analysis.

### Example 26

The aqueous dispersion of modified carbon black product prepared in Example 25 above (56 g, 7.14% solids) and 10 g sodium methacrylate were combined in a 250 mL round-bottom flask and mixed for 30 minutes to dissolve the sodium methacrylate. To this was added 28.8 g isopropanol and 24 g 2-ethylhexylmethacrylate. The resulting pigment/monomer mixture was sonicated for 30 minutes with a sonic probe and then purged with nitrogen for 14 hours.

In a separate vessel, 0.253 g ethylene dithiol disodium acetate was dissolved in 3.6 g water, and the solution was purged with nitrogen for 14 hours. To this solution was added 0.071 g of Cu(I)Br, and the mixture was stirred at 50° C. for 1 hour. The resulting solution was then added to the flask containing the pigment/monomer mixture, and the flask was then heated to 70° C. After 16 hours, the mixture was decanted into a 1 L beaker, and the flask was then refilled with water. This was sonicated for thirty minutes. The pH of the mixture was adjusted to 9, and this was sonicated for an additional thirty minutes. The resulting pH was found to be 8.3 and was adjusted again to 9. The dispersion was filtered through a coarse mesh cloth. The 1 L dispersion was purified by diafiltration with water for 6 volumes, and then concentrated to 8.4% solids. The resulting polymer modified pigment dispersion was further sonicated for an additional 90 minutes, forming a dispersion having an average particle size of 152 nm. A small sample was purified by soxhlet extraction in THF and found to be 50% by weight polymer by TGA analysis.

Using this polymer modified pigment dispersion, an inkjet ink composition was prepared using the procedure shown in Example 6. Images produced from this inkjet ink composition were found to have very good resistance to rub and water (waterfastness).

### Example 27

A polymer modified pigment dispersion was prepared using the procedure described in Example 26 above, except using the modified pigment of Example 24, 2 g of sodium methacrylate, and 4.8 g of 2-ethylhexylmethacyrlate to prepare the pigment/monomer mixture. The resulting polymer modified pigment dispersion (10.2% solids) was found to have an average particle size of 201 nm. A small sample was purified by soxhlet extraction with THF and found to be 29% by weight polymer by TGA analysis.

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An inkjet ink composition comprising a) a vehicle and b) a polymer modified pigment comprising a pigment having attached at least one polymeric group,
wherein the polymer modified pigment is prepared by a process comprising the steps of:
a) polymerizing at least one polymerizable monomer from a modified pigment, wherein at least one of the polymerizable monomers comprises a reactive functional group, and
b) converting at least a portion of the reactive functional groups to a second group.

2. The inkjet ink composition of claim 1, wherein the second group is an ionic group and wherein the polymeric group is an ionic polymeric group.

3. The inkjet ink composition of claim 2, wherein the reactive functional group is an ionizable group.

4. The inkjet ink composition of claim 3, wherein the reactive functional group is a cationizable group and wherein the ionic group is a cationic group.

5. The inkjet ink composition of claim 4, wherein the step of converting at least a portion of the reactive functional groups comprises quaternizing at least a portion of the cationizable groups.

6. The inkjet ink composition of claim 4, wherein the step of converting at least a portion of the reactive functional groups comprises protonating at least a portion of the cationizable groups.

7. The inkjet ink composition of claim 4, wherein the cationizable group is an amino group and the cationic group is a quaternary ammonium group.

8. The inkjet ink composition of claim 4, wherein at least one of the polymerizable monomers is dimethylaminoethyl methacrylate, dimethylaminoethyl acrylate, 2-vinyl pyridine, 4-vinyl pyridine, or derivatives thereof.

9. The inkjet ink composition of claim 3, wherein the ionizable group is a carboxylic acid group.

10. The inkjet ink composition of claim 9, wherein the step of polymerizing further comprises adding at least one transition metal catalyst.

11. The inkjet ink composition of claim 10, wherein the transition metal catalyst comprises a transition metal and a ligand coordinated to the transition metal.

12. The inkjet ink composition of claim 11, wherein the transition metal is copper, iron, rhodium, nickel, cobalt, palladium, or ruthenium.

13. The inkjet ink composition of claim 11, wherein the transition metal catalyst is at least partially soluble in the step of polymerizing, has a redox potential of less than about 500 mV, has an acidity constant of the ligand upon protonation greater than about 10^{-4,} has a conditional disproportionation constant less than about 1000, and has a conditional metal-radically transferable atom or group philicity of greater than about 10.

14. The inkjet ink composition of claim 11, wherein the ligand is a heterodonor ligand.

15. The inkjet ink composition of claim 14, wherein the heterodonor ligand is the sodium salt of ethylenedithiol diacetic acid.

16. The inkjet ink composition of claim 2, wherein the reactive functional group is a hydrolyzable ester group and wherein the ionic group is an anionic group.

17. The inkjet ink composition of claim 16, wherein the step of converting at least a portion of the reactive functional groups comprises hydrolyzing at least a portion of the hydrolyzable ester groups.

18. The inkjet ink composition of claim 2, wherein the reactive functional group is an ester group capable of being dealkylated and wherein the ionic group is an anionic group.

19. The inkjet ink composition of claim 18, wherein the step of converting at least a portion of the reactive functional groups comprises dealkylating at least a portion of the ester groups to form an anionizable group.

20. The inkjet ink composition of claim 19, wherein the step of converting at least a portion of the reactive functional groups further comprises converting the anionizable group to the anionic group.

21. The inkjet ink composition of claim 18, wherein the ester group is a t-butyl ester group and wherein the anionic group is a salt of a carboxylic acid.

22. The inkjet ink composition of claim 18, wherein at least one of the polymerizable monomers comprising a reactive functional group is t-butyl methacrylate, t-butyl acrylate, or derivatives thereof.

23. The inkjet ink composition of claim 1, wherein the vehicle is an aqueous vehicle.

24. The inkjet ink composition of claim 1, wherein the vehicle is a non-aqueous vehicle.

25. The inkjet ink composition of claim 1, wherein the pigment is an organic colored pigment comprising a blue pigment, a black pigment, a brown pigment, a cyan pigment, a green pigment, a white pigment, a violet pigment, a magenta pigment, a red pigment, a yellow pigment, an orange pigment, or mixtures thereof.

26. The inkjet ink composition of claim 1, wherein the pigment is a carbon product.

27. The inkjet ink composition of claim 26, wherein the carbon product is graphite, carbon black, vitreous carbon, activated charcoal, carbon fiber, or activated carbon.

28. The inkjet ink composition of claim of claim 1, wherein the polymeric group a homopolymer, a random copolymer, a block copolymer, a graft copolymer, a branched copolymer, or an alternating copolymer.

29. The inkjet ink composition of claim 1, wherein the modified pigment is present in an amount of between about 1 and about 30 percent solids in the polymerization step.

30. The inkjet ink composition of claim 29, wherein the modified pigment is present in an amount of between about 5 and about 10 percent solids in the polymerization step.

31. The inkjet ink composition of claim 1, wherein the polymer modified pigment comprises the pigment having attached at least one transferable atom or group.

32. The inkjet ink composition of claim 31, wherein the polymerizable monomer is a radically polymerizable monomer and wherein the transferable atom or group is a radically transferable atom or group.

33. The inkjet ink composition of claim 32, wherein the radically transferable atom or group comprises a halogen.

34. The inkjet ink composition of claim 33, wherein the radically transferable atom or group comprises a haloalkyl ester group, a haloalkyl ketone group, or a haloalkyl amide group.

35. The inkjet ink composition of claim 33, wherein the radically transferable atom or group has the formula: 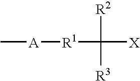
wherein A is attached to the pigment, A and R¹ independently represent a bond, a substituted or unsubstituted arylene, alkylene, aralkylene, or alkarylene group, —O—, —S—, —OR⁴—, —NR⁴—, —S(═O)—, —C(═O)—, —COO—, —OC(═O)—, —COO-ALK—OOC— wherein ALK is a branched or unbranched C2-C8 alkylene group, —CONR⁴—, —NR⁴C(═O)—, —SO₂—, —P(═O)₂O—, or —P(═O)₂(OR⁴)—; wherein R⁴ is a hydrogen or an alkyl or an aryl group; R² and R³ independently represent H, an alkyl group, an aryl group, —OR⁵, —NHR⁵, —N(R⁵)_{2,} or —SR⁵; wherein R⁵ is independently an alkyl group or an aryl group; and X is a halogen.

36. The inkjet ink composition of claim 32, wherein the step of polymerizing further comprises adding at least one transition metal catalyst.

37. The inkjet ink composition of claim 36, wherein the transition metal catalyst comprises a transition metal and a ligand coordinated to the transition metal.

38. The inkjet ink composition of claim 37, wherein the transition metal is copper, iron, rhodium, nickel, cobalt, palladium, or ruthenium.

39. The inkjet ink composition of claim 36, wherein the transition metal catalyst comprises a copper halide.

40. The inkjet ink composition of claim 39, wherein the copper halide is Cu(I)Br or Cu(I)Cl.

41. The inkjet ink composition of claim 36, wherein the radically transferable atom or group and the transition metal catalyst are present in a ratio of between about 20:1 and about 500:1.

42. The inkjet ink composition of claim 41, wherein the ratio is between about 100:1 and about 300:1.

43. The inkjet ink composition of claim 31, wherein the modified pigment comprises a pigment having further attached at least one non-transferable atom or group.

44. The inkjet ink composition of claim 1, wherein the step of polymerizing is an atom transfer radical polymerization.

45. The inkjet ink composition of claim 1, wherein the step of polymerizing is a stable free radical polymerization.

46. The inkjet ink composition of claim 1, wherein the step of polymerizing is a reversible addition-fragmentation chain transfer polymerization.

47. The inkjet ink composition of claim 1, wherein the step of polymerizing is a group transfer polymerization.

48. An inkjet ink composition comprising a) a vehicle and b) a polymer modified pigment comprising a pigment having attached at least one polymeric group,
wherein the polymer modified pigment is prepared by a process comprising the step of polymerizing at least one polymerizable monomer from a modified pigment, and
wherein the polymer modified pigment has an average particle size of less than or equal to about 500 nm in the inkjet ink composition.

49. The inkjet ink composition of claim 48, wherein the average particle size is less than or equal to about 350 nm.

50. The inkjet ink composition of claim 48, wherein the average particle size is greater than or equal to about 50 nm.

51. The inkjet ink composition of claim 48, wherein the modified pigment comprises the pigment having attached at least one transferable atom or group.

52. The inkjet ink composition of claim 48, wherein at least one of the polymerizable monomers comprises a hydrophilic nonionic group.

53. The inkjet ink composition of claim 52, wherein at least one of the polymerizable monomers is 2-hydroxyethyl methacrylate, 2-hydroxyethyl acrylate, N-vinyl pyrrolidone, N-vinyl acetamide, or derivatives thereof.

54. The inkjet ink composition of claim 48, wherein at least one of the polymerizable monomers comprises a reactive functional group and wherein the polymer modified pigment is prepared by a process further comprising the step of converting at least a portion of the reactive functional groups to an ionic group.

55. The inkjet ink composition of claim 54, wherein the polymeric group comprises the ionic group in an amount of from about 0.3 to about 12 mmoles of ionic groups per gram of polymer modified pigment.

56. The inkjet ink composition of claim 55, wherein the polymeric group comprises the ionic group in an amount of from about 0.05 to about 4 mmoles of ionic groups per gram of polymer modified pigment.

57. An inkjet ink composition comprising a) a vehicle and b) a polymer modified pigment comprising a pigment having attached at least one polymeric group,
wherein the polymer modified pigment is prepared by a process comprising the step of polymerizing at least one polymerizable monomer from a modified pigment, and
wherein the polymer is present in an amount of between about 10 and about 1000 parts per hundred parts of pigment.

58. The inkjet ink composition of claim 57, wherein the polymer is present in an amount of between about 40 and about 400 parts per hundred parts of pigment.

59. The inkjet ink composition of claim 57, wherein the modified pigment comprises the pigment having attached at least one transferable atom or group.

60. An inkjet ink composition comprising a) a vehicle and b) a polymer modified pigment comprising a pigment having attached at least one polymeric group,
wherein the polymer modified pigment is prepared by a process comprising the step of polymerizing at least one polymerizable monomer from a modified pigment, and
wherein the polymeric group comprises at least one ionic group in an amount of from about 0.05 to about 4 mmoles of ionic groups per gram of polymer modified pigment.
